(19) United States
(12) Patent Application Publication
(10) Pub. No.: US 2021/0028427 A1
(43) Pub. Date: Jan. 28, 2021

(54) NOVEL COMPOSITE SEPARATOR, BATTERY AND BATTERY PACK

(71) Applicant: AAB Technology (HK) Limited, Kowloon (HK)

(72) Inventor: Zhonglai Pan, Hong Kong (CN)

(21) Appl. No.: 16/938,825

(22) Filed: Jul. 24, 2020

Related U.S. Application Data
(60) Provisional application No. 62/879,152, filed on Jul. 26, 2019.

(30) Foreign Application Priority Data
Apr. 28, 2020 (CN) 202010348996.0

(51) Int. Cl. H01M 2/16; H01M 2/14

(52) U.S. Cl. CPC H01M 2/162; H01M 2/145; H01M 2/1673

(57) ABSTRACT

The present invention discloses a composite separator including a first layer and a second layer; the first layer is a dendrite carrying layer and the second layer is a dendrite inhibiting layer. The first layer includes a Gurley value from about 0.05 s/100 cc to about 50 s/100 cc, and the second layer includes a Gurley value which is greater than 50 times the Gurley value of the first layer.

### CROSS REFERENCE TO RELATED APPLICATIONS

This application claims priority to U.S. Provisional Patent Application No. 62/879,152 filed on Jul. 26, 2019, and China Patent Application No. 202010348996.0 filed on Apr. 28, 2020; each of which is hereby incorporated by reference in its entirety.

### FIELD OF THE INVENTION

The present invention relates to a composite separator; and a battery and battery pack containing the composite separator, belonging to the field of electrochemical cell. More particularly, this invention relates to a composite separator with good safety performance.

### BACKGROUND OF THE INVENTION

With high energy density and long cycle life, Lithium ion batteries are widely used today. However, these non-aqueous lithium ion batteries display poor safety characteristics, are toxic and can pose environmental risks.

Recently, various alternatives such as aqueous electrolyte based rechargeable batteries have been sought after that are with no fire/explosion risk and are environment-friendly. In particular, aqueous electrolyte batteries containing anodes with zinc metal have shown to be promising alternatives due to their abundance, low cost, and nontoxic properties. However, there are complications associated with these types of batteries. Battery cell performance is often limited during the repeated charging and discharging process, by the dissolution of zinc and the un-uniform buildup of zinc metal precipitate depositing on the surfaces of the anode commonly referred to as zinc dendrite formation. The effects of these limitations can be disastrous since the presence of dendrite formation can result in potentially an inner short circuit which can pose a shortened battery cycle life.

In order to overcome the aforementioned limitations, electrolyte solutions were developed to suppress inner short-circuit risk. Additives were added to electrolyte to promote uniform buildup of zinc metal deposition and inhibit dendrite formation. However, the addition of additives to electrolyte were not able to attain acceptable inhibiting effects at complicated and variable service environments. Alternatively, non-porous solid electrolyte film was commonly used as separators to prevent zinc dendrites impaling through and short-circuits. However, low ion diffusion speed in the film caused by the non-porous solid electrolyte were found to deteriorate the battery performance such as high rate charging/discharging, resistance, etc.

For the foregoing reasons, there exists a need for a composite separator which effectively inhibits dendrite formation and enhances cycling stability. Further, it would be advantageous to have a separator for a battery to be fast and stable in response to charge/discharging and be able to maintain its performance for prolonged periods of time. Still further, it would be advantageous to have a separator which is efficient, safe and low cost.

### SUMMARY

The present invention is directed to apparatuses and methods to a composite separator; and a battery and battery pack containing the composite separator. In accordance with the present invention, the composite separator comprises a first layer and a second layer; wherein the first layer is a dendrite carrying layer and the second layer is a dendrite inhibiting layer. Preferably, the first layer comprises a Gurley value from about 0.05 s/100 cc to about 50 s/100 cc, and the second layer comprises a Gurley value which is greater than 50 times the Gurley value of the first layer.

In a preferred embodiment of the disclosure, the Gurley value of the second layer is more than 500 times that of the first layer.

In a most preferred embodiment of the disclosure, the Gurley value of the second layer is 500-10,000 times that of the first layer.

In a preferred embodiment of the disclosure, the Gurley value of the second layer is from about 100 s/100 cc to about 2250 s/100 cc.

In a most preferred embodiment of the disclosure, the Gurley value of the second layer is from about 150 s/100 cc to about 2250 s/100 cc.

In a preferred embodiment of the disclosure, the first layer is at least one of non-woven fabric, mat membrane, and micro-porous membrane.

In a preferred embodiment of the disclosure, the non-woven fabric or mat membrane is made of at least one of polypropylene fiber, vinyl fiber, polyester fiber, nylon fiber, aramid fiber, polyurethane fiber, acrylic fiber, viscose fiber, glass fiber, spandex fiber, carbon fiber, polyacrylate fiber and polyimide fiber; and the micro-porous membrane is made of at least one of nylon, polyethylene, polypropylene, polyethylene/propylene composite material, polyvinylidene fluoride, polyester, aramid fiber, acrylic fiber, spandex, polyacrylate and polyimide.

In a preferred embodiment of the disclosure, the second layer is made of at least one of polyethylene micro-porous layer, polypropylene micro-porous layer, polyethylene/propylene composite micro-porous layer, polyvinylidene fluoride micro-porous layer, nylon micro-porous layer, polyester micro-porous layer, aramid micro-porous layer, acrylic micro-porous layer, spandex micro-porous layer, polyacrylate micro-porous layer, polyimide micro-porous layer and ceramic micro-porous layer.

The composite separator of the present disclosure can be prepared in a variety of ways: simply stacking the first and the second layers, or bonding the first and the second layers of the composite separator with a general separator adhesive, or coating the second layer on top of the first layer or extruding them together.

According to an embodiment of the present disclosure, there is provided a battery containing the composite separator.

In a preferred embodiment of the disclosure, the battery shall be one that generates dendrite in the process of use and includes a negative pole and a positive pole. Preferably, the first layer of the separator is adjacent to the negative pole of the battery and the second layer is adjacent to the positive pole of the battery.

The composite layer of the present disclosure is especially suitable for a battery that generates dendrites. Preferably, the first layer is a dendrite carrying layer and configured to accommodate metal deposition between electrodes, and can be referred to interchangeably herein as a “metal accommodation layer” or “metal carrying layer”. The second layer is a dendrite inhibiting layer configured to retard metal deposition between the electrodes, and can be referred to as a “metal inhibiting layer”. To minimize battery failure in the wake of dendrite formation, it is necessary for the “metal carrying layer” to be adjacent to and face toward the electrode that generates dendrites. If the order of separator is changed, the battery would be easily short-circuited, resulting in battery failure and safety problems. Therefore, the order of separator preferably should not be altered. However, if the batteries do not generate dendrites, the order of separator can be altered.

Typically, the batteries generating dendrites are negative metal batteries. Preferably, the negative pole of the battery should be metal.

When the separator herein is applied on the negative metal battery that generates dendrites, the first layer of such separator should face toward the negative pole and the second layer should face toward the positive pole. For example, the first layer of the separator adjacent to the negative pole and the second layer adjacent to the positive pole. The metal may be zinc, lithium, sodium etc.

According to an embodiment of the present disclosure, there is provided a battery pack.

The battery pack includes batteries comprising the composite separator.

In a preferred embodiment of the present disclosure, the first layer of the composite separator comprises a Gurley value from about 0.05 s/100 cc to about 50 s/100 cc, and the second layer of the composite separator comprises a Gurley value more than 50 times that of the first layer. Preferably, the first layer accommodates and carries dendrites and the second layer retards dendrites. In a preferred embodiment, the first layer is adjacent to and faces towards the negative pole and the second layer is adjacent to and faces towards the positive pole.

The separator of the present disclosure has the following significant advantages: 1) contributing to inhibiting and/or preventing the formation of dendrites, as well as the short circuiting of batteries; and 2) improving the safety and cycle performance of the battery.

### BRIEF DESCRIPTION OF THE DRAWINGS

These and other features, aspects, and advantages of the present invention will become better understood with reference to the following description, appended claims and accompanying drawings where:

FIG. 1 is a schematic diagram of a zinc battery containing a composite separator according to an embodiment of the present disclosure.

FIG. 2 shows the process of metal deposition according to one embodiment of the present disclosure.

FIG. 3 compares the discharge capacity retention (%) of two batteries, namely one with a conventional general separator and the other with a differential composite separator according to an embodiment of the present disclosure, whose cycle numbers are different from each other.

FIG. 4 illustrates a process for manufacturing a zinc ion battery according to an embodiment of the present disclosure.

FIG. 5 is a schematic diagram of Comparative Example 2, showing the discharge capacity retention (%) of the separator mounted in the inverted order, the general separator and the composite separator described in an embodiment of the present disclosure.

These and other features, aspects, and advantages of the present invention will become better understood with reference to the following description.

### DETAILED DESCRIPTION OF EMBODIMENTS

In the descriptions presented below, reference may be made to a zinc ion battery. However, the apparatus and methods described may be applicable to other cells and batteries that are not zinc based. For example, an electrochemical cell of a battery having an anode which can form dendrites, and the apparatuses and methods presented herein may be applied to resist, inhibit, suppress and/or prevent one or more dendrites from causing a short circuit between the electrodes of the cell.

FIG. 1 shows a view of a zinc-ion battery according to an embodiment of the present invention, comprising a composite separator that inhibits and/or prevents the diffusion of zinc dendrites between the electrodes. The battery of the disclosure may comprise any zinc-ion battery in any embodiment, including a zinc-ion battery containing a liquid electrolyte, a zinc-ion battery containing a solid electrolyte, a zinc-ion battery containing at least one liquid electrode or a combination of some zinc-ion batteries.

Details are shown in FIG. 1. A battery 100 usually consist of one or more battery cells, which may include a corresponding cathode current collector 102, a corresponding cathode 104 composed of an active material, a separator 108, a corresponding anode 110 composed of an active material, and a corresponding anode current collector 112. The cathode may have a cathode coating, and the anode may also have an anode coating. The battery 100 may include the liquid electrolyte 106, wherein components 102, 104, 108, 110, and 112 are immersed.

Generally, the anode 110 of a zinc-ion battery contains zinc. The zinc-ion battery may comprise at least one cathode, one anode, one composite separator and electrolyte. Charging and discharging such a zinc batteries will lead to the formation of a zinc structure on the surfaces of anodes. Such a structure, commonly referred to herein as zinc dendrites, will “grow” outward from the anode due to repeated charging and discharging of a zinc battery.

When the zinc dendrite grows to the cathode, the zinc containing zinc dendrite will create a short circuit between the electrodes. Such short circuit can result in battery failure and brings further potential safety hazards.

An embodiment of the current disclosure comprises partially manufacturing a battery which comprises one or more batteries capable of resisting dendrite growth between the electrodes. For example, the battery may have one or more zinc cells, each of which has anodes that contains zinc.

Composite Separator with Differential Diffusion

Details are shown in FIG. 1. According to a preferred embodiment of the present disclosure, the battery 100 comprises a separator 108, which allows transporting some charge carriers containing metal ions, for example, zinc ions, between electrodes 104 and 110. In a preferred embodiment of the disclosure, the separator 108 is a composite separator of at least two layers; a first separator layer 108a and a second separator layer 108b. For some preferred embodiments of the present disclosure, the first layer 108a is used to carry the zinc deposited between electrodes 104 and 110. Such first layer is a dendrite carrying layer and when the metal is zinc, can be referred to as “zinc metal accommodation layer” or “zinc metal carrying layer” both terms can be interchangeably used herein. The second layer 108b is used to delay metal deposition between electrodes 104 and 110. Such second layer is a dendrite inhibiting layer and when the metal is zinc, can be called “zinc inhibiting layer”. In the most preferred embodiment of the disclosure, there is a huge diffusion difference in the composite separator 108.

Such diffusion difference exists between the first layer 108a and the second layer 108b. This diffusion differentiation can be characterized by the Gurley value. In the most preferred embodiment of the disclosure, the Gurley value of the second layer 108b is more than 50 times (G2/G1≥50) that of the first layer 108a. Generally, the Gurley value of the first layer 108a is from about 0.05 s/100 cc to about 50 s/100 cc—G1, while that of the second layer 108b is from about 100/100 cc to about 2,000 s/100 cc—G2.

Gurley values are commonly used by those skilled in the art to indicate permeability, which refers to the time it takes for a specific amount of air to pass through a designated area of separator at a given pressure. When the porosity and thickness of the separator are constant, the Gurley value reflects the curvature of pores. Therefore, lower Gurley values mean higher porosity as well as lower curvature.

In an embodiment of the disclosure, the first layer 108a carries deposited zinc, and has a porosity of approximately 50% to 90%. Preferably, according to the designed capacity, the thickness of the first layer 108a should be 10 to 50 times of the theoretical deposition thickness. The theoretical deposition thickness is calculated according to the thickness of zinc deposited uniformly on the negative pole and formed into a dense metal layer relative to the total capacity of active capacity of active materials in the positive pole.

In an embodiment of the disclosure, the second layer 108b (zinc inhibiting layer) delays zinc metal deposition and has a porosity rate of approximately 25% to 75%.

Furthermore, the second layer 108b preferably should be less than or equal to 64 μm in thickness. The composite separator with diffusion difference in the disclosure is advantageous by providing a space for the zinc accommodation layer 108a and the dendrite inhibiting layer 108b. It can resist, inhibit and/or prevent the formation of dendrites and the short circuits of batteries.

In various embodiments of the present disclosure, the first layer 108a of the composite separator 108 can be one or a composite of more than two selected from the group consisting of non-woven fabric, mat membrane and micro-porous membrane.

The non-woven fabric or mat membrane can be at least one of polypropylene fiber, vinyl fiber, polyester fiber, nylon fiber, aramid fiber, polyurethane fiber, acrylic fiber, viscose fiber, glass fiber, spandex fiber, carbon fiber, polyacrylate fiber and polyimide fiber, and the micro-porous membrane can be made of at least one of nylon, polyethylene, polypropylene, polyethylene/propylene composite material, polyvinylidene fluoride, polyester, aramid fiber, acrylic fiber, spandex, polyacrylate and polyimide.

In various embodiments of the present disclosure, the second layer 108b of the composite separator 108 can be made of at least one or a composite of more than two selected from the group consisting of polyethylene micro-porous layer, polypropylene micro-porous layer, polyethylene/propylene composite micro-porous layer, polyvinylidene fluoride micro-porous layer, nylon micro-porous layer, polyester micro-porous layer, aramid micro-porous layer, acrylic micro-porous layer, spandex micro-porous layer, polyacrylate micro-porous layer, polyimide micro-porous layer and ceramic micro-porous layer.

Preferably, the first layer of the separator 108a should be adjacent to and face towards the negative pole and the second layer 108b should be adjacent to and face towards the positive pole.

In a most preferred embodiment of the disclosure, the surface of the anode 110 can be in contact with an adjacent proximal side of the first layer 108a of the separator partition. Further, the distal or other side of the first layer 108a, can also be in contact with an adjacent proximal side of the second layer 108b. The other side of second layer 108b can be in contact with the cathode 104, according to one embodiment of the disclosure, the battery 100 should be configured to be: the anode/the first metal dendrite carrying layer/the second metal dendrite inhibiting layer/the cathode.

The zinc battery may also comprise a multi-layer structure composed of a cylindrical coil.

In accordance with the present disclosure, the composite separator with differential diffusion preferably is used to deposit zinc.

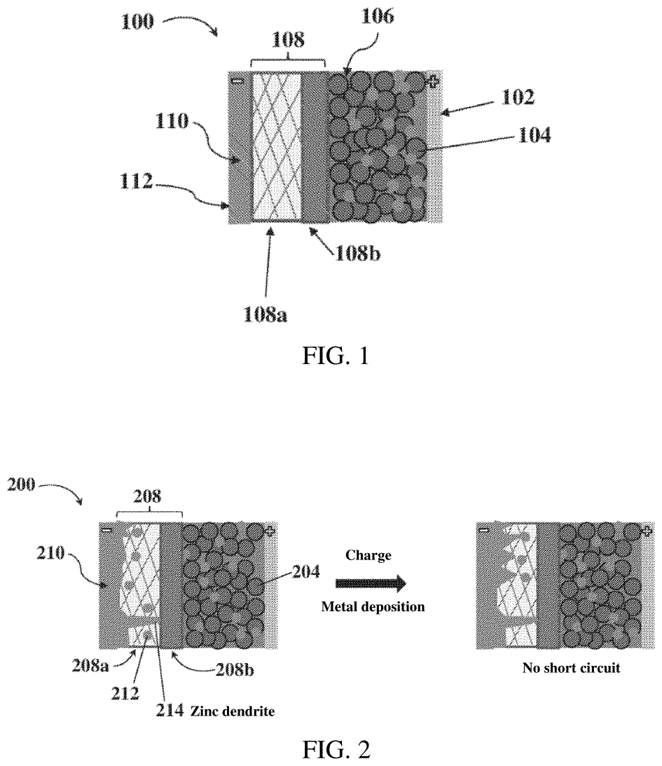

In another preferred embodiment of the disclosure, as shown in FIG. 2, the battery 200 includes an anode 210, a cathode 204 and a composite separator 208. The composite separator 208 comprising a first layer which is a dendrite carrying layer of metal accommodation layer (also known as first metal carrying layer) 208a, and a second layer which is a metal dendrite inhibiting layer 208b. As shown in FIG. 2, metal dendrite 214 grows from the surface of the anode 210.

In a preferred embodiment, the anode 210 comprises of one or more materials containing zinc. With the long-term re-charging and re-discharging of the battery 200, the zinc dendrite 214 can grow outward from the anode 210 through first layer 208a of the separator to the adjacent surface of the second layer 208b. Thus the zinc dendrite 214 can directly be in contact with the second layer 208b. In a preferred embodiment of the current disclosure, the second layer 208b of the separator, although permeable to zinc ion 212, is resistant to the zinc dendrite 214. Thus, the dendrite 214 reaching the second layer 208b of the separator will be obstructed by the second layer 208b, preventing or inhibiting its growth. In this way, the possibility of short circuit resulting from contact of zinc dendrite 214 and electrodes 210, 204 can be further eliminated. FIG. 2 illustrates the soaring Gurley value (due to the plummeted ion diffusion rate in the second layer 108b inhibiting layer), which hinders the growth of metal dendrites.

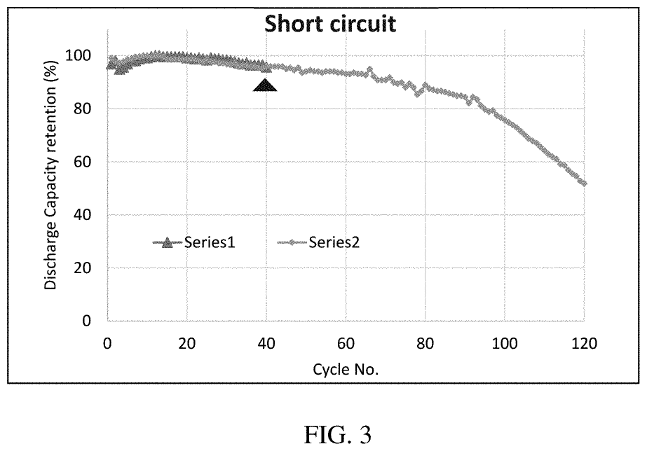

FIG. 3 is a comparison diagram of the discharge capacity retention (%) under different cycle numbers between the general separator and the composite separators 108 and 208 with differential diffusion in the disclosure. As shown in FIG. 3, when a conventional general separator (for example, absorbent glass mat separator) undergoes 40 cycles, a short circuit occurs, resulting in battery failure at 40 cycles, a short circuit occurs, resulting in battery failure. Instead, the composite separator 108 with differential diffusion, due to the first layer 108a (zinc dendrite carrying layer) and the second layer 108b (zinc dendrite inhibiting layer), still works normally after 120 cycles, and does not lead to the short circuit of batteries.

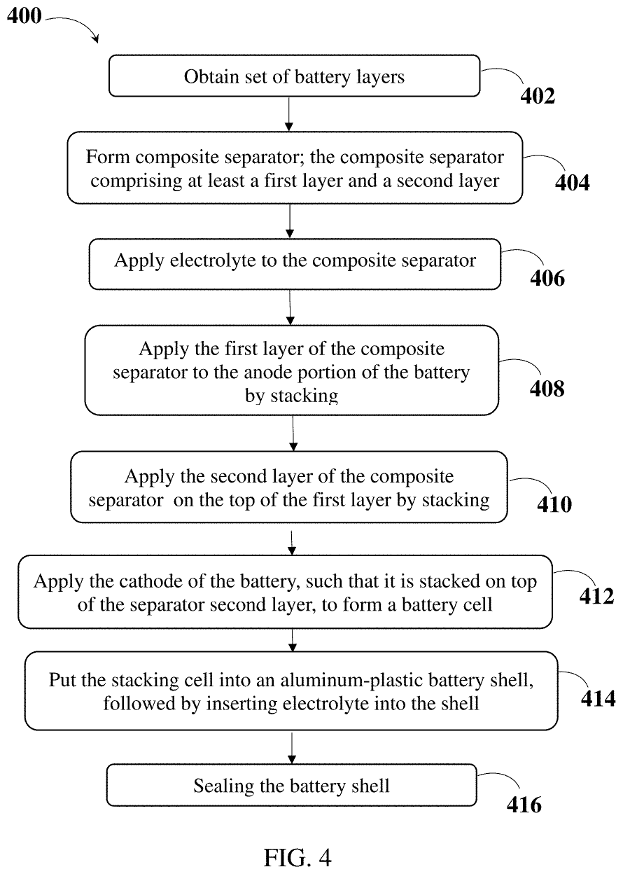

FIG. 4 illustrates a process 400 of manufacturing a zinc ion battery according to an embodiment of the present disclosure. First, obtaining a set of battery parts 402, including various electrodes; an anode and a cathode. Next, forming a composite separator 404. The composite separator includes a first layer and a second layer. Preferably, the first layer is a dendrite carrying layer and configured to accommodate metal deposition between electrodes, and can be referred to interchangeably herein as a “metal accommodation layer” or “metal carrying layer”. Preferably, the second layer is a dendrite inhibiting layer configured to retard metal deposition between the electrodes, and can be referred to as a “metal inhibiting layer”. In an embodiment of the present disclosure, when the metal is zinc, the first layer is referred herein as a zinc carrying layer or zinc accommodation layer, and the second layer referred to as a zinc inhibiting layer. Applying an electrolyte solution to the composite separator 406, which contains at least the first layer and the second layer. Then, stacking the first layer, for example, the zinc carrying layer, of the composite separator with the anode 408 of the battery. Next, applying the second layer, for example, the zinc inhibiting layer, on top of the first layer by stacking 410. The second layer should be kept upward and located on the top of the first layer. Then, stacking the battery cathode on top of the second layer of the separator to form a battery cell 412. Next, placing the stacked cell& in an aluminum-plastic battery shell wherein the electrolyte 414 is added. Finally, sealing the battery shell 416 after being placed in a vacuum for 12 hours.

The above mentioned disclosure has many advantages, including: the composite separator with differential diffusion herein used for a battery, which is safe, effective and low-cost. The composite separator overcomes the traditional anode short circuit due to the formation of dendrites, improves battery capacity and prolongs battery cycle life. The separator also overcomes the problems of high resistance in the traditional solid electrolyte separator, and improves the capacity utilization, and large-rate and low-temperature charging/discharging of the battery.

In accordance to the present disclosure, when the anode is made of zinc, the dendrites may cause an electrical short circuit. The composite separator with a zinc carrying layer and a zinc inhibiting layer can resist, retard, inhibit and/or prevent short circuits arising from the formation of zinc dendrites, thereby improving the battery capacity and prolonging the cycle life, which makes it quite valuable. It satisfies the ever-growing demand of users for compact power sources, especially for long life in battery storage.

The following description will detail the preferred embodiments of the disclosure, and the disclosure will thereby not be limited to the embodiments.

### Example 1

Stacking the 0.4 mm fiberglass separator with the 32 μm PP/PE separator, so as to form a two-layer composite separator. Gurley value of 0.4 mm fiberglass separator is 0.8 s/100 cc. Gurley value of 32 μm PP/PE separator is 1140 s/100 cc. The ratio of the Gurley values of the second to first layers of the composite separator is 1425.

Stacking the zinc anode with the fiberglass separator of the composite separator.

Stacking the other side of the composite separator with the cathode to form a battery cell. The elements in the cell from the anode to the cathode are: the anode/0.4 mm fiberglass separator/32 μm PP/PE separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Embodiment 1, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.20 Ah, and the battery has not been short-circuited after 300 cycles of charging and discharging.

### Example 2

Stacking the 0.4 mm fiberglass separator with the 64 μm PP/PE separator, so as to form a two-layer composite separator. Gurley value of 0.4 mm fiberglass separator is 0.8 s/100 cc. Gurley value of 64 μm PP/PE separator is 2250 s/100 cc. The ratio of the Gurley values of the second to first layers of the composite separator is 2812.

Stacking the zinc anode with the fiberglass separator of the composite separator.

Stacking the other side of the composite separator with the cathode to form a battery cell. The elements in the cell from the anode to the cathode are: the anode/0.4 mm fiberglass separator/64 μm PP/PE separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Embodiment 2, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.18 Ah, and the battery has not been short-circuited after 350 cycles of charging and discharging.

### Example 3

Stacking the 0.4 mm fiberglass separator with the 44 μm PET separator, so as to form a two-layer composite separator. Gurley value of 0.4 mm fiberglass separator is 0.8 s/100 cc. Gurley value of 44 μm PET separator is 210 s/100 cc. The ratio of Gurley values of the second to first layers of the composite separator is 263. Stacking the lower side (with lower Gurley value) of the composite separator with the zinc anode, and the other side (with higher Gurley value) with the cathode to form a battery cell. The elements in the cell from the anode to the cathode are: the anode/0.4 mm fiberglass separator/44 μm PET separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Embodiment 3, as shown in below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.2 Ah, and the battery begins to short-circuit after 150 cycles of charging and discharging.

### Example 4

Stacking the 0.4 mm fiberglass separator with the 22 μm PET separator, so as to form a two-layer composite separator. Gurley value of 0.4 mm fiberglass separator is 0.8 s/100 cc. Gurley value of 22 μm PET separator is 110 s/100 cc. The ratio of the Gurley values of the second to first layers of the composite separator is 138. Stacking the side (with lower Gurley value) of the composite separator with the zinc anode, and the other side (with higher Gurley value) with the cathode to form a battery cell. The elements in the cell from the anode to the cathode are: the anode/0.4 mm fiberglass separator/22 μm PET separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Embodiment 4, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.21 Ah, and the battery begins to short-circuit after 97 cycles of charging and discharging.

### Example 5

Stacking the 0.3 mm fiberglass separator with the 32 μm PP/PE separator, so as to form a two-layer composite separator. Gurley value of 0.3 mm fiberglass separator is 0.7 s/100 cc. Gurley value of 32 μm PP/PE separator is 1140 s/100 cc. The ratio of the Gurley values of the second to first layers of the composite separator is 1629. Stacking the side (with lower Gurley value) of the composite separator with the zinc anode, and the other side (with higher Gurley value) with the cathode to form a battery cell. The elements in the cell from the anode to the cathode are: the anode/0.3 mm fiberglass separator/32 μm PP/PE separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Embodiment 5, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.21 Ah, and the battery began to short-circuit after 189 cycles of charging and discharging.

### Comparative Example 1

Stacking the 0.4 mm fiberglass separator (Gurley value of 0.8 s/100 cc) with the zinc anode/cathode to form a battery cell. The elements in the cell from the anode to the cathode are: the anode/the composite separator/the cathode. Loading the prepared battery cell into the battery shell, adding zinc ion battery electrolyte solution thereto, then placing such battery shell in vacuum for 12 hours, finally, sealing the battery shell to obtain the zinc battery containing composite separators with differential diffusion.

Carrying out the cycle performance test on the zinc battery obtained from Comparative example 1, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.21 Ah, and the battery begins to short-circuit after 37 cycles of charging and discharging.

### Comparative Example 2

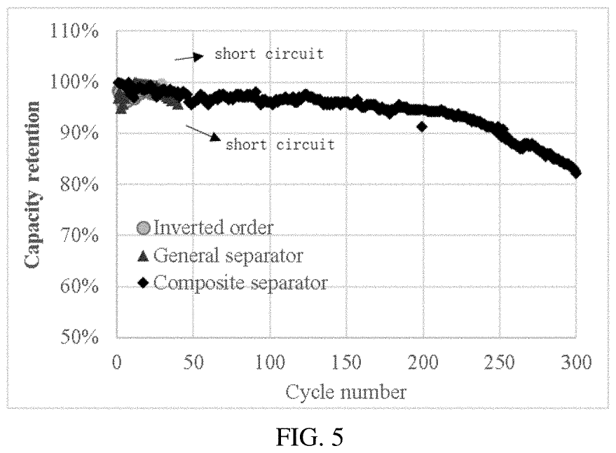

FIG. 5 is a schematic diagram of Comparative Example 2, showing the discharge capacity retention (%) of the separator mounted in the inverted order, a conventional general separator (for example, absorbent glass mat separator) and the composite separator described in an embodiment of the present invention.

Stacking the 0.4 mm fiberglass separator (Gurley value of 0.8 s/100 cc) with the 32 μm PP/PE separator (Gurley value of 1,140 s/100 cc), so as to form a two-layer composite separator. The ratio of the Gurley values of the second to first layers of the composite separator is 0.0007. Stacking the side (with higher Gurley value) of the composite separator with the zinc anode, and the other side (with lower Gurley value) with the cathode to form a battery cell. The elements in the cell from the anode to the cathode are: the anode/the second layer of the composite separator/the first layer of the composite separator/the cathode. Loading the prepared battery cell into the battery shell, adding zinc ion battery electrolyte solution thereto, then placing such battery shell in vacuum for 12 hours, finally, sealing the battery shell to obtain the zinc battery containing a reverse differentiated composite separator.

Carrying out the cycle performance test on the zinc battery obtained from Comparative example 2, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.18 Ah, and the battery begins to short-circuit after 15 cycles of charging and discharging.

### Comparative Example 3

Stacking the 0.4 mm fiberglass separator (Gurley value of 0.8 s/100 cc) with the 40 μm PET separator (Gurley value of 10 s/100 cc), so as to form a two-layer composite separator. The ratio of the Gurley values of the second to first layers of the composite separator is 13. Stacking the side (with lower Gurley value) of the composite separator with the zinc anode, and the other side with the cathode to form a battery cell. The elements in the cell from the anode to the cathode are: the anode/the first layer of the composite separator/the second layer of the composite separator/the cathode. Loading the prepared battery cell into the battery shell, adding zinc ion battery electrolyte solution thereto, then placing such battery shell in vacuum for 12 hours, finally, sealing the battery shell to obtain the zinc battery containing a composite separator with weak differential diffusion.

Carrying out the cycle performance test on the zinc battery obtained from Contrast example 3, as shown below:

a. Charging procedure: charging the 0.5 C battery to 2.05V under constant current and then to 0.075 C under constant voltage, standing for 3 minutes; b. Discharging procedure: discharging the 0.5 C battery to 1.4V under constant current, standing for 3 minutes; c. Repeat steps a and b until the battery shorts out.

The initial discharging capacity of the battery is 0.15 Ah, and the battery begins to short-circuit after 40 cycles of charging and discharging.

The previously described disclosure has many advantages. The advantages include a composite separator with differential diffusion herein used for a battery, which is safe, effective and low cost. Then composite separator overcomes the traditional anode short circuit due to the formation of dendrites which can lead to an electrical short circuit. This differentiated diffusion composite separator comprising a zinc accommodation layer and a zinc inhibition layer has shown to resist, impeded, inhibit and/or prevent the short circuit caused by formation of zinc dendrites extending the battery capacity and cycle life, which is makes this especially valuable in meeting the growing demands to find compact power sources specifically with long-life solutions in grid storage.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A composite separator comprising:
a first layer and,
a second layer,
wherein the first layer is a dendrite carrying layer and the second layer is a dendrite inhibiting layer;
whereby the first layer comprises a Gurley value from about 0.05 s/100 cc to about 50 s/100 cc, and the second layer comprises a Gurley value which is greater than 50 times the Gurley value of the first layer.

2. The composite separator according to claim 1, wherein the Gurley value of the second layer is more than 500 times that of the first layer.

3. The composite separator according to claim 1, wherein the Gurley value of the second layer is from about 500 to about 10,000 times that of the first layer.

4. The composite separator according to claim 1, wherein the Gurley value of the second layer is from about 100 s/100 cc to about 2250 s/100 cc.

5. The composite separator according to claim 4, wherein the Gurley value of the second layer is from about 150 s/100 cc to about 2250 s/100 cc.

6. The composite separator according to claim 1, wherein the first layer comprises at least one material selected from the group consisting of non-woven fabric, mat membrane and micro-porous membrane.

7. The composite separator according to claim 1, wherein the first layer is at least one of non-woven fabric, mat membrane and micro-porous membrane.

8. The composite separator according to claim 1, wherein the first layer is at least two of non-woven fabric, mat membrane and micro-porous membrane.

9. The composite separator according to claim 6, wherein the non-woven fabric or mat membrane comprises at least one of polypropylene fiber, vinyl fiber, polyester fiber, nylon fiber, aramid fiber, polyurethane fiber, acrylic fiber, viscose fiber, glass fiber, spandex fiber, carbon fiber, polyacrylate fiber and polyimide fiber, and the micro-porous membrane is made of at least one of nylon, polyethylene, polypropylene, polyethylene/propylene multi-layer composite material, polyvinylidene fluoride, polyester, aramid fiber, acrylic fiber, spandex, polyacrylate and polyimide.

10. The composite separator according to claim 1, wherein the second layer comprises at least one of polyethylene micro-porous layer, polypropylene micro-porous layer, polyethylene/propylene composite micro-porous layer, polyvinylidene fluoride micro-porous layer, nylon micro-porous layer, polyester micro-porous layer, aramid micro-porous layer, acrylic micro-porous layer, spandex micro-porous layer, polyacrylate micro-porous layer, polyimide micro-porous layer and ceramic micro-porous layer.

11. A composite separator comprising:
a first layer and,
a second layer,
wherein the first layer is a dendrite carrying layer and the second layer is a dendrite inhibiting layer;
whereby the first layer comprises a Gurley value from about 0.05 s/100 cc to about 50 s/100 cc, and the second layer comprises a Gurley value from about 150 s/100 cc to about 2250 s/100 cc.

12. A battery comprising:
a negative pole,
a positive pole; and,
the composite separator of claim 1.

13. The battery according to claim 12, wherein the battery generates dendrite in the process of use;
whereby the first layer is adjacent to the negative pole and the second layer is adjacent to the positive pole.

14. The battery according to claim 12, wherein the negative pole of the battery comprises metal.

15. The battery according to claim 14, wherein the metal comprises zinc.

16. A battery pack, comprising the battery of claim 12.

17. A method of fabricating a battery comprising:
obtaining a set of battery parts,
wherein the set of battery parts comprise electrodes; an anode and a cathode;
forming a composite separator, wherein the composite separator comprises at least a first separator layer and a second separator layer;
applying an electrolyte to the composite separator;
applying the first separator layer to the anode;
applying the second separator layer on the top of the first separator layer;
applying the cathode of the battery to the separator second layer to form a battery cell;
putting the battery cell into a shell;
inserting an electrolyte into the shell; and,
sealing the shell;
wherein the first separator layer is a dendrite carrying layer and the second separator layer is a dendrite inhibiting layer;
whereby the first layer comprises a Gurley value from about 0.05 s/100 cc to about 50 s/100 cc, and the second layer comprises a Gurley value which is greater than 50 times the Gurley value of the first layer.
